(19) United States
(12) Patent Application Publication
(10) Pub. No.: US 2021/0175747 A1
(43) Pub. Date: Jun. 10, 2021

(54) DEVICE FOR CONTACTLESS INDUCTIVE ENERGY TRANSMISSION AND METHOD FOR OPERATING THE DEVICE

(71) Applicant: Weidmüller Interface GmbH & Co. KG, Detmold (DE)

(72) Inventors: Olaf GRÜNBERG, Blomberg (DE); Fabian LANG, Lemgo (DE)

(21) Appl. No.: 16/606,265

(22) PCT Filed: Apr. 17, 2018
(86) PCT No.: PCT/EP2018/059708

§ 371 Date: Oct. 18, 2019

(30) Foreign Application Priority Data
Apr. 19, 2017 (DE) 102017108302.2

(51) Int. Cl. H02J 50/12; H01F 38/14; H02J 50/80

(52) U.S. Cl. CPC H02J 50/12; H02J 50/80; H01F 38/14

(57) ABSTRACT

The invention relates to a device for contactless inductive energy transmission from a primary portion to a secondary portion that both include at least one coil that can be inductively coupled to each other via an air gap. At least one of the primary portion and the secondary portion includes a condition monitoring device for monitoring at least one condition parameter of the primary portion and the secondary portion. The condition monitoring device of the primary portion is coupled to a data transmission device of the primary portion and the condition monitoring device of the secondary portion is coupled to a data transmission device of the secondary portion. In addition, the condition monitoring device also includes a parameterization unit that can be used to adjust and modify individual condition parameters.

### CROSS-REFERENCE TO RELATED APPLICATIONS

This application is a § 371 National Stage Entry of PCT/EP2018/059708 filed Apr. 17, 2018. PCT/EP2018/059708 claims priority of DE102017108302.2 filed Apr. 19, 2017. The entire content of these applications are incorporated herein by reference.

### BACKGROUND OF THE INVENTION

The invention relates to a device for contactless inductive energy transmission from a primary portion to a secondary portion that both include at least one coil that can be inductively coupled to each other via an air gap. The invention also relates to a method for operating such a device of this type.

Compared with plug connectors, in which energy transmission takes place via contact elements that are connected and disconnected mechanically, devices for contactless energy transmission have advantages in terms of wear due to a large number of plugging cycles or heavy vibrations. In addition, contact burnout during plugging or unplugging under an electrical load is prevented. The risk of electric are formation when plug connectors with a high electrical load are disconnected also does not exist for contactless energy transmission devices. Finally, with contactless energy transmission, galvanic separation exists between the primary portion and the secondary portion, which may be required, for example for use in the medical field. Furthermore, the avoidance of mechanically intermeshing contacts makes it possible to provide a device with the smoothest possible surfaces, making them ideally suited for applications with higher demands for cleanliness and hygiene, for example in the food sector.

In the field of automation, high abrasion resistance also makes contactless inductive energy transmission useful, for example for transmitting energy to an interchangeable tool of a robot.

Patent Application Publication No. WO 2013/087676 A2 describes a device for contactless inductive energy transmission from a primary portion to a secondary portion, which can replace a mechanical plug connection for energy transmission, for example, to an interchangeable tool of a robot. The primary and secondary portions both include at least one coil that can be inductively coupled to each other, each of which interacts with a ferrite core. Due to its permeability, the ferrite core increases the magnetic flux such that even with small device sizes and small transmission surfaces, large quantities of electric power can be transmitted.

In this case, as a result of the high magnetic flux, energy transmission is possible when the primary and secondary portions are not minimally distanced apart, but when a gap between them is present. Similarly, energy transmission can also take place in the case of a certain lateral displacement of the primary and secondary portions, as in situations where the coils of the primary and secondary portions are not located on the same axis.

In addition, DE 10 2015 113 723 A1 discloses a device for contactless inductive energy transfer from a primary portion and a secondary portion, each having at least one coil which are inductively coupled to one another.

### BRIEF SUMMARY OF THE INVENTION

It is a goal of the present invention to expand the opportunities for use of such a device for contactless energy transmission, especially for use in the field of automation.

A device for contactless inductive energy transmission from a primary portion to a secondary portion is provided in which both the primary portion and the secondary portion include at least one coil that can be inductively coupled to each other via an air gap, wherein the primary portion and/or the secondary portion include a condition monitoring device for repeatedly or preferably continuously monitoring at least one condition parameter of the primary portion and/or the secondary portion. The condition monitoring device also includes a parameterization unit with which at least one of the condition parameters can be adjusted and/or modified.

In this way a collection of one multiple parameters of the device for contactless energy transmission is realized, which distinctly simplifies the control and supervision of this device. Preferably, evaluation of the data is performed with an evaluation unit making it possible to generate warning signals as soon as the actual behavior of the device deviates from a preset nominal behavior.

Advantageously, it is possible not only to monitor at least one of the condition parameters or values, such as limit values during operation, but also to adjust or change the condition parameters using the terminal unit, i.e., to perform parameterization. For this purpose, the condition monitoring device is advantageously expanded by the addition of a setting function or a parameterization unit.

Accordingly, there is also provided an operating method for a device for contactless inductive energy transmission from a coil of a primary portion to a coil of a secondary portion via an air gap which forms part of a control system. During the inductive energy transmission from the primary portion to the secondary portion, at least one condition parameter is collected with at least one condition monitoring device of the primary portion and/or the secondary portion, especially by way of sensors. A data transmission device transmits the condition parameters monitored in data form to a control unit and/or a terminal unit. The at least one condition monitoring device has a parameterization unit which can set or change at least one limit value for an individual condition parameter or for multiple condition parameters or at least one of the values correlated therewith.

In addition, at least one condition parameter or of information correlated with the at least one condition parameter is displayed, especially on the display of a terminal unit.

Preferably, device also includes a control system having at least one terminal unit, a control unit and at least one field unit.

According to a preferred embodiment, the condition monitoring device of the primary portion is coupled with a data transmission device of the primary portion and/or the condition monitoring device of the secondary portion is coupled with a data transmission device of the secondary portion, so that the data observed can be further transmitted internally or externally.

Preferably, the condition monitoring device of the primary portion is coupled with at least one sensor for monitoring at least one condition parameter of the primary portion, especially the primary coil, and/or the condition monitoring device of the secondary portion is coupled with at least one sensor for monitoring at least one condition parameter of the secondary portion, especially to the secondary coil.

According to advantageous embodiments that further improve the application possibilities, the data transmission device of the primary portion is designed for transmitting data via at least one data bus to a control unit or gateway or directly to a terminal unit. In addition, according to another embodiment, the data transmission device of the primary portion is also designed for transmitting data over at least one data bus to the data transmission device of the secondary portion. Advantageously, the control unit is coupled with at least one terminal unit for data input and/or data output, especially data display. More preferably, the at least one terminal unit has a visual display screen designed for visual display of the at least one condition parameter or of information correlated with at least one condition parameter, and/or for setting/changing at least one of the condition parameters—especially in the sense of a limit value.

To optimize the operation of the device or the system, internal parameters—especially such as current, voltage, temperature and/or efficiency are measured or determined. By parameterization, a user can parameterize the device or the method and as a result, especially determine and set respective limit values for these parameters. The limit values may be determined by evaluating a combination of sensor data.

If a limit value set by parameterization is exceeded or a critical condition is reached, the system will issue an initial warning. If the system or the device continues to remain in the critical condition, an additional warning may be issued, for example after a predetermined time. In the case of yet a third warning, it is possible for the system to shut down, This procedure represents considerable protection for the device and the system. Furthermore the device or the system is monitored (for example, at the air gap) and, at the same time, by supervising the internal parameters, optimal operation of the system is ensured, which implicitly translates into an increase in availability of the plant in which the system is installed.

According to another embodiment of the invention, independent or controlled functional operations, with or without parameterized notification, such as switching off the transmission and/or reducing the power or the like may be performed.

The data transfer device of the secondary portion is designed for transmission of data over at least one data bus or several data buses to at least one field unit. This option for data exchange with the field unit will expand the possibilities for using the device for contactless energy transmission.

According to another embodiment, both the primary portion and the secondary portion comprise a data transmission device for transmitting data across the air gap. When used in an industrial environment, especially in the field of automation, in addition to supplying the supply current, a data connection is frequently required, for example in the case of an interchangeable robot arm tool. The transmission of current and data together through a single device with only one primary and one secondary portion simplifies the set-up and maintenance of the system. In an advantageous embodiment of the device, the transmission of the data is performed optically via the air gap. Here, a data transmission channel is selected that does not interfere with inductive energy transmission. Preferably, the data transmission devices are located centrally in and concentric with the coils. In this manner, the space located in the center of the coils can be utilized so that the data transmission devices can be integrated in the primary or secondary portion without an increase in their dimensions compared with systems used for energy transmission alone. In an additional embodiment of the device, the data transmission devices each have at least one sending element and at least one receiving element centrally arranged and surrounded by several receiving elements.

### BRIEF DESCRIPTION OF THE DRAWINGS

Other objects and advantages of the invention will be described with reference to the accompanying drawings, in which:

FIG. 1 is a sectional view of a device for contactless energy transmission;

FIG. 2 is a cross-sectional view taken along line A-A of the device of FIG. 1;

FIG. 3 is a schematic view of a control system with an embodiment of a device for contactless energy transmission;

FIG. 4 is a schematic view of the device for contactless energy transmission of FIG. 3;

FIG. 5 is a schematic view of a second embodiment of a device for contactless energy transmission for the control system of FIG. 3;

FIG. 6 is a schematic representation of a first screen surface for displaying condition information of the device of FIG. 4 or 5; and

FIG. 7 is a schematic representation of a variant of a screen surface for displaying condition information of the device of FIGS. 4 or 5.

### DETAILED DESCRIPTION

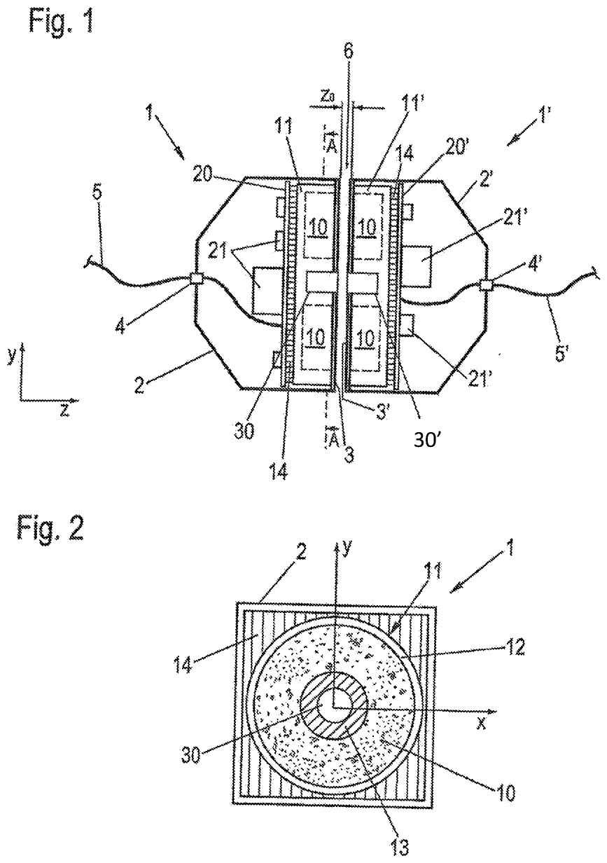

FIG. 1 is a schematic sectional image of a first device for contactless energy transmission from a primary portion 1 to a secondary portion 1′. In FIG. 2, the primary portion 1 is shown in a section along line A-A of FIG. 1.

Elements assigned to the primary portion 1 (also called primary-side elements) are marked with reference symbols without an apostrophe. Elements assigned to the secondary portion 1′ (also called secondary-side elements) bear reference symbols with a corresponding apostrophe.

Primary-side and secondary-side elements having the same or a comparable function are provided with reference symbols with the same number. When a reference is not being made specifically to the primary or secondary side, reference symbols without an apostrophe are used, referring to both sides.

Both primary portion 1 and secondary portion 1′ have a housing 2, which can be made of a material common for plug housings such as plastic, aluminum or stainless steel. The housings 2 are made in the form of a half-shell, wherein their open side is closed with a cover plate 3. In the rearward area, pointing away from the cover plate 3, a cable pass-through 4 or a plug connection for a connecting cable 5 is provided in the housing 2. Preferably, the connecting cable 5 is a hybrid line, which has connecting lines for energy supply (including the energy to be transmitted) as well as data lines. Alternatively, energy and data can also be carried in separate lines. Instead of fixed lines, plug connectors can also be arranged on the housing 2.

Directly behind the cover plate 3, in both the primary side and the secondary side a coil 10 is arranged and wound on a ferrite core 11 or on a coil body inserted in the ferrite core 11. The coil 10 can be wound with a single conductor. To reduce the skin effect, however, the use of multiple-conductor high-frequency stranded wire is preferred.

In the embodiment shown, the ferrite core 11 on the primary and secondary sides is a round cup core with an outer rim 12 and a concentric inner dome 13. A core of this type is also called an E-core which is cylindrically symmetrical. Here, the cross sections of the outer rim 12 and the inner dome 13 are approximately of the same size to achieve a homogeneous magnetic flux density, taking the different leakage fields in the ferrite core 11 into consideration. The use of ferrite cores with different geometries is also possible. For example, square or rectangular cores with round or square or rectangular ferrite cores can be used. Coils without coil bodies, e.g., with conductors bonded together, may also be used. The ferrite cores 11 are open toward the respective cover plate 3, whereas on the opposite side the outer rim 12 and the inner dome 13 are connected together over a cup base. In both cases the coil 10 is laid in the annular trench between the outer rim 12 and the inner dome 13. Any gap that may still be present between the outer and inner rim of the coil 10 and the ferrite core 11 can be filled with a heat-conducting medium which is capable of heat dissipation to the housing.

In operation, for contactless inductive energy transmission, the primary portion 1 and the secondary portion 1′ are placed a small distance apart with their cover plates 3, 3′ facing one another. This distance, which forms an air gap 6, is shown in FIG. 1 as the transmission distance Z₀.

The size of a permissible transmission distance Z₀ is in the range of 0 to a few millimeters or centimeters depending on the size, especially the diameter of the coils 10 or ferrite cores 11. The direction along the axis of the primary-side coil 10 will be designated as the z-direction, and the corresponding axis as the z-axis. The x and y-directions or axes travel perpendicular to the z-axis in the plane of the cover plate 3.

In operation, an alternating current is applied to the primary side coil 10, also designated as the primary coil 10. Preferably, a resonance loop is formed from the primary coil 10 and a resonance capacitor. The frequency is in the range of several kilohertz (kHz) to several hundred kHz. A frequency in the range of several tens of kHz is preferred. The alternating current applied to the primary coil 10 is supplied by a power inverter. In this power inverter, a pulse width modulation method (PWM method) can be used to produce the alternating current. The power inverter together with monitoring and control arrays is located on a circuit board 20 inside the housing 2 of the primary portion 1. FIG. 1 illustrates non-limiting examples of electronic components 21 on circuit board 20.

To protect the power inverter from resonance magnification of the amplitude in the resonance loop, formed from the resonance capacitor and the primary coil 10, the resonance loop is operated in a slightly hyper-resonant mode, thus at frequencies above the resonance frequency.

During energy transmission, the magnetic coupling between the primary coil 10 and the secondary-side coil 10′, referred to as the secondary coil 10′, is especially efficient due to the presence of the ferrite cores 11 and 11′. In the secondary coil 10′, a voltage is induced which, following rectification, voltage conversion (and if necessary, voltage stabilization) is available at the output voltage at the connecting cable 5′ for output of the transmitted energy. The electronic components on the secondary side are likewise located on a circuit board 20′, where individual electronic components 21′ are provided as illustrated in the earlier examples. Advantageously, the secondary coil can have a center tap, so that a synchronous rectifier can be used.

In the embodiment shown, no intermeshing guide or positioning elements are provided for laterally aligning the primary portion 1 and the secondary portion 1′ relative to one another. Owing to the absence of such elements, the primary portion 1 and the secondary portion 1′ can also be brought together into the operating position or separated from one another by a lateral movement, i.e., a movement in the x and/or y-direction. This proves especially advantageous specifically in the field of automation, since an additional axial movement of the primary and secondary portions 1, 1′ relative to one another is not necessary to establish or break a connection. However, such guiding or positioning elements may also be provided in alternative embodiments depending on the intended use.

The ferrite cores 11, 11′ allow a high magnetic flux density, through which efficient energy transmission is possible, even in the case of small coil volumes. In this process, the transmission is tolerant to lateral displacement of the primary portion 1 and the secondary portion 1′ relative to one another. This is highly advantageous, for example in the field of automation, since the high positioning accuracy required for establishing a conventional plug connection can be dispensed with.

For data transmission, the device is provided with a condition monitoring device 50. Condition monitoring device 50 includes at least one data transmission device 30, 30′, in order to transmit data via at least one data interface with one and/or multiple data buses within the device and/or to external components outside of the device or receive data from these components.

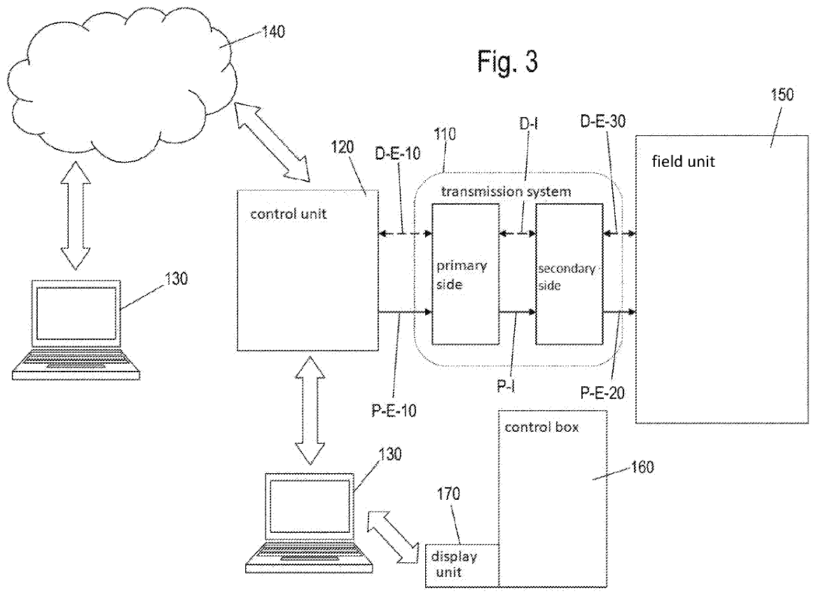

FIG. 3 is a schematic view of a control system 100 with a device 110 for contactless energy transmission (called the transmission system here). This device 110 has a primary portion or side 1 and a secondary side 1′, which is surrounded by a rectangle rounded in the corner regions, purely for illustrating the functional coherence.

The control system 100 has a number of buses. A bus is a subsystem of the control system that transmits data or energy unidirectionally or bidirectionally between units in the control system with a processor, especially a CPU, or between other components of individual units in the control system 100. In this sense the device 110 for contactless energy transmission is one of the units of the control system. The buses of the control system 100 may be designed as parallel or as bit-serial. Their architecture may be linear and/or stellate. There are also external buses of the control system 100. Within the meaning of this application, all buses outside of the device 110 for contactless energy transmission connect with units of the control system 100 that are external to the device 110. There are also internal buses of the control system 100. Within the meaning of this application, these are buses with which energy and/or data or signals are transmitted within the device 110. The device 110 has at least one microcontroller (not visible here) or another processor, especially a CPU.

Units of the control system 100 also include at least one control unit 120, especially a gateway at least one terminal unit (terminal communication unit 130), at least one cloud 140 (in the sense of a computer apparatus, especially a memory apparatus with its own CPU capability, accessible via the Internet), and at least one field unit 150. A control box 160 with a display unit 170 is shown as an option.

An internal energy bus P-I provides the contactless internal energy transmission between the primary portion 1 and the secondary part 1′. Also, an internal data bus D-I provides cableless or contactless internal data transmission between the primary portion 1 and the secondary portion 1′. To realize this data connection, the primary portion 1 and the secondary portion 1′ each have a data transmission device 30, 30′ which form part of the data transmission device of the device 100 (FIGS. 1, 3, 4).

In addition, the primary portion 1 is connected with the control unit 120, for example a gateway, over at least one external energy bus P-E-10 and at least one external data bus D-E-10 and preferably over a second external data bus D-E-20 for cable-connected cableless data transmission. The control unit 120 or the gateway in turn can be connected at least over the first external data bus or a data bus of a different design which may use another transmission protocol with the at least one terminal unit 130 for data output, such as a display, and for data input to display condition data of the control system, especially of the device for contactless energy transmission, and/or to input control commands.

The control unit 120 can also be connected to several of the terminal units 130. Here, two separate terminal units 130 are provided. In this case, one of the terminal units 130 is connected directly over the first external data bus with the control unit 120 and the other terminal unit 130 is indirectly connected via a cloud connection 140 and the first external data bus is connected with the control unit 120. For data transmission to the at least one external data bus D-E-10, a variety of systems with different physical and data-technology designs can be used, for example field bus systems of various types such as Profibus or Ethernet. Here, the terminal unit 130 is coupled with a second terminal unit, which is designed as a display apparatus 170 on a control box 160 as shown in FIG. 3. In this way, a display can be provided directly on or in a control box.

The secondary portion 1′ is also connected over a second external energy bus P-E-20 with at least one field unit 150, for example with at least one drive, pulse generator or sensor or the like, to supply the secondary portion with energy.

The secondary portion 1′ is likewise connected over a third external data bus D-E-30 with at least one of the field units 150 to transmit control data or signals to them or to receive control data or signals from them. The third external data bus D-E-30, especially its transmission protocol, can be designed in the same way as the first external data bus.

In this way, remote control of the device 110 for contactless energy transmission and preferably also of the field unit 150 connected to the secondary portion 1′ of the device 110 for contactless energy transmission is possible.

Furthermore, remote supervision and diagnosis of the device 110 for contactless energy transmission is possible. Preferably, remote supervision and diagnosis of the field unit 150 connected to the secondary portion 1′ of the device is also possible.

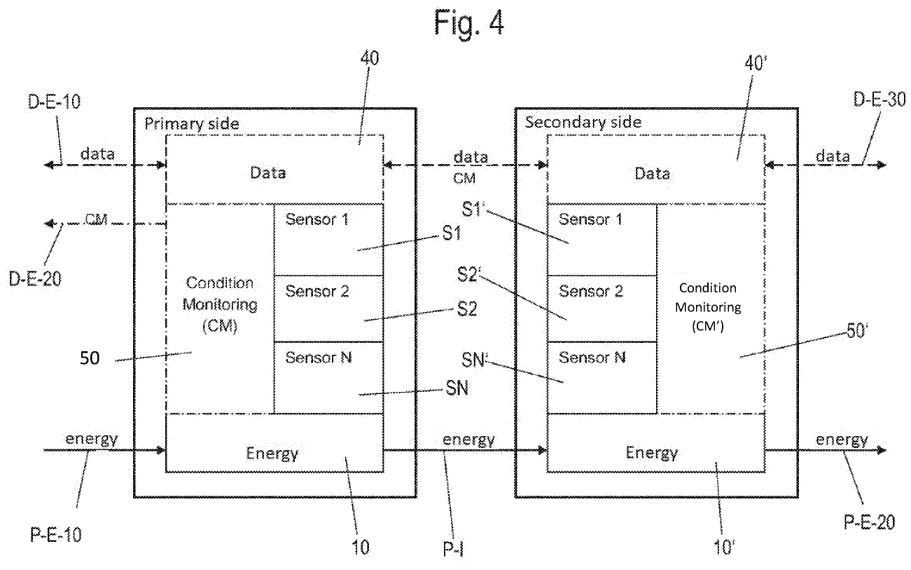

FIG. 4 shows a schematic view of a device 110 for contactless energy transmission of the type in FIG. 1.

Also shown are the energy transmission channels or buses P-E-10, P-I and P-E-20 and the data transmission channels or data buses D-E-10, the optional second data bus D-E-20 and the optional third external data bus D-E-30.

For energy transmission, the primary portion 1 includes the components described above, especially the primary coil 10. For data transmission, at least the primary portion 1 has a data transmission device 40. The data transmission device 40 is connected to the first external data bus D-E-10. The first data bus can be designed for parallel data transmission. It is connected with a second external data bus D-E-20. This second external data bus D-E-20 can be a data bus for serial data transmission, e.g., RS 232 or RS 485.

The second data bus D-E-20 is an advantageous option, but need not necessarily be implemented. The second external data bus D-E-20 is preferably connected with the control unit 120.

The primary portion 1 includes a condition monitoring device 50. At least one sensor (sensors S1, 52, . . . , SN) is connected to the condition monitoring device 50.

In this way the condition monitoring device 50 collects at least one condition parameter of the device for contactless energy transmission, via the primary portion 1, especially in the operation of the device 110 for contactless energy transmission during energy transmission.

The condition monitoring device 50 is coupled with the data transmission device 40 of the primary portion 1. This can pass along the condition parameters collected by the condition monitoring device 50 of the primary portion 1 to one data bus or via any one of the data buses, in this case the second external data bus D-E-20 to the control unit 120 which can transmit the information via a data bus over the Internet or the like to one of the terminal units 130. It is advantageous, though not necessary, to use a separate data bus (for example a serial data bus) to transmit the collected condition parameters.

Optionally, it is provided that the secondary portion 1′ has a data transmission device 40′, preferably a data transmission device 40′ with a first data transmission device 30′ for internal data transmission via the internal bus D-I between the primary portion 1 and the secondary portion 1′. In addition, the data transmission device 40′ can be designed for transmission and receipt of data over the third external bus D-E-30 to the field units 150. In this way these data are transferrable, and data can be transferred from the field units 150 to the primary portion 1 and from there to the control unit 120 and further over the first external data bus back to the terminal units 130.

Optionally, the secondary portion also includes a condition monitoring mechanism 50′. Here again, at least one sensor (S1′, S2′, . . . , SN′) is connected to the condition monitoring device 50′ to detect condition parameters of this type.

The condition monitoring device 50′ thus serves for collecting at least one condition parameter of the device for contactless energy transmission, especially of the secondary portion 1′.

The condition monitoring device 50′ is coupled with the data transfer device 40′ of the secondary portion 1′. The data transfer device 40′ can pass along the condition parameters detected by the condition monitoring device 50′ of the secondary portion 1′ via the internal bus D-I to the primary portion 1 and from there to the control unit 120, which in turn can transmit the information directly or indirectly over the internet or the like to the terminal unit 130. This advantageously expands the condition monitoring by providing an option for direct monitoring of the condition of the secondary portion 1′.

Condition parameters can be monitored and supervised in this way in the primary portion 1 or in the secondary portion 1′. These parameters include but are not limited to: voltage and current, especially input voltage; effective input current and/or output current and effective output current at the primary portion 1 and/or at the secondary portion 1′.

Additional condition parameters that can be monitored and supervised include: effective input current; status; internal temperature; housing temperature/surface; ambient temperature at the primary portion 1 and/or the secondary portion 1′.

Still other condition parameters that can be monitored and/or supervised include parameters of the stray field sensor technology (voltage in inductances), distance between primary portion 1 and secondary portion 1′; angle between primary portion 1 and secondary portion 1′; quality of the input voltage; input power; output power; efficiency; object recognition FOD (changes in magnetic field), identification of the remote module; operating point; master data of the secondary side or the secondary portion 1′; and master data of the primary side or the primary portion 1.

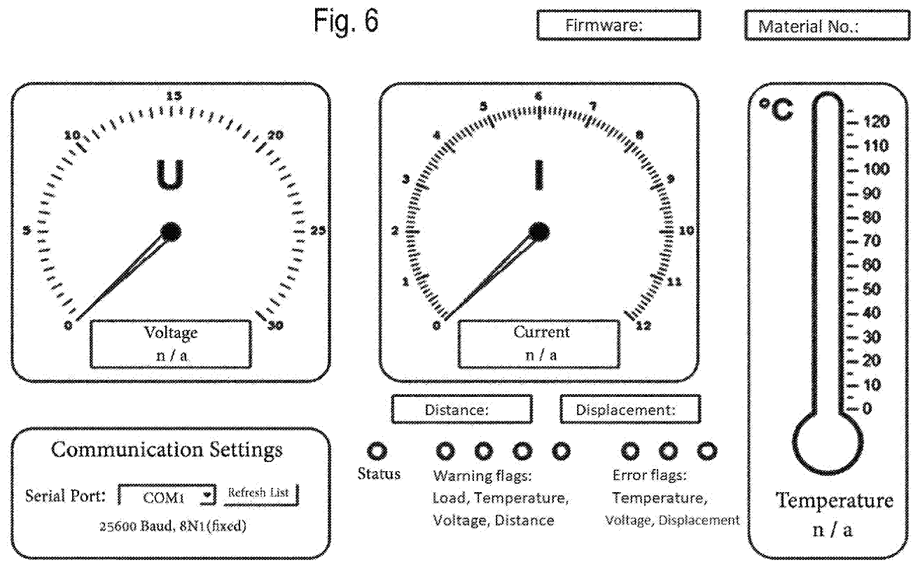

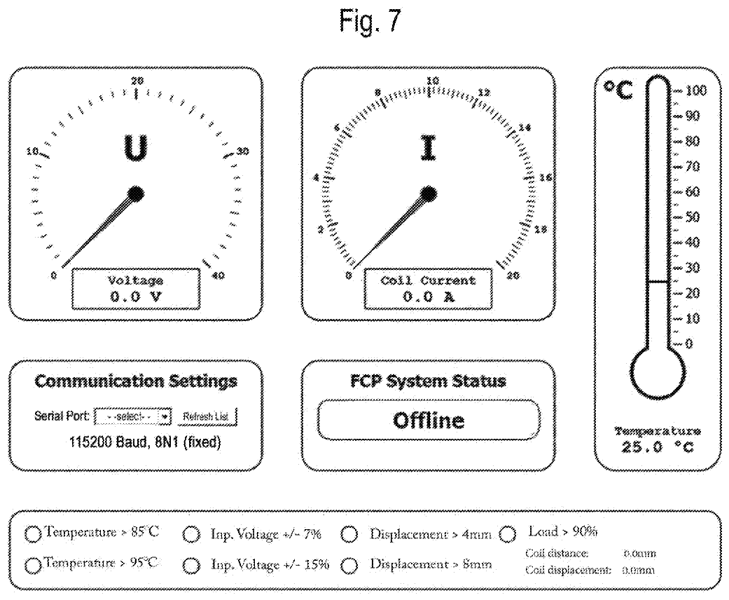

These parameters are detectable and/or displayable, especially on a display of the terminal unit 130. If a PC or a mobile unit such as a cell phone or the like) is used as the at least one terminal unit 130, the screen surface can be designed, for example, in the manner of FIG. 6 or 7, and may have at least one display field designed to display the individual parameters.

Optionally, it is also advantageously possible not only to monitor at least one of the parameters during operation, but also to adjust and/or change them. In this way the condition monitoring device 50, 50′ is functionally expanded by a setting function or a parameterization unit.

Preferably, parameters (e.g., current setpoint values or limit values) are set or changed by inputting the parameters on a screen surface of the terminal unit 130. From the terminal unit 130, these inputs are communicated via the Internet, to the control unit 120 and the external data bus D-E-10 of the device 110 for contactless energy transmission as setpoint values or setpoint parameters. For this purpose, in another embodiment, a mobile device with a wireless interface, such as Bluetooth or NFC (Near Field Communication) can also be used for parameterizing as well as for identification. It is advantageous if the device 110 for contactless energy transmission is provided with an Internet-capable identification address for identification and addressing of the device in the control system, especially via the Internet.

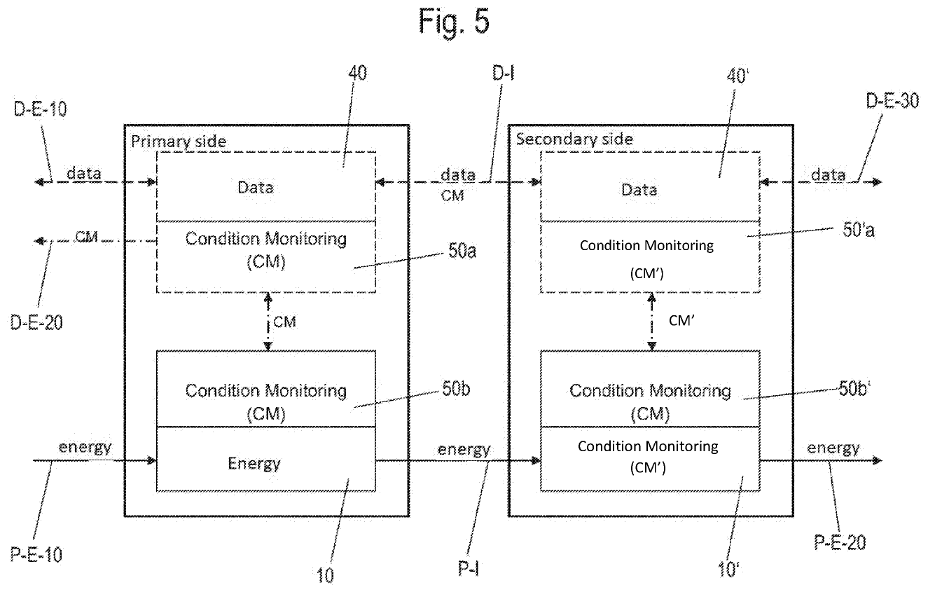

According to FIG. 5, the condition monitoring device 50, 50′ of the primary portion 1 and/or the secondary portion 1′ each have several sections 50a, 50b or 50a′ and 50b′ that can be connected over an internal data bus CM, CM′. This can be configured in the i²C standard.

One of the sections 50a, 50a′ is directly coupled with the respective data transfer device 40, 40′ and the other section 50b, 50b′ is directly assigned to the respective primary coil 10 or secondary coil 10′ to collect condition parameters directly at these components and forward them over the respective data bus to the control unit 120 and from there on to the terminal unit or units 130. The data transmission unit 40, 40′ and energy transmission unit 10, 10′ can be integrated in a housing and consolidated locally, which simplifies handling. However, it is also conceivable to construct them separately from one another and if desired, even locate them at different places. Then, the data and energy transmission units can each have their own condition monitoring devices 50a, 50b; 50a′, 50b′ (similar to FIG. 5).

FIGS. 6 and 7 illustrate possible detected parameters output onto a screen surface of a terminal unit, e.g., a PC. Such parameters include voltage, coil current or temperature (for example, the primary coil 10 of the primary portion 1). In addition, data transmission parameters such as transmission rate may also be displayed (transmission rate and the like) as well as other parameters. It is also conceivable to link several parameters and output or display the linked values. Furthermore, it is conceivable to set threshold values or the like, for example, to indicate attainment or deviation, especially on a display of the terminal unit.

Thus, it is advantageously possible, in case of a deviation from a specified value or value range or a specified value behavior (e.g., in the case of a deviation of a measured value from a gradient), to output an error code (error flag). A notification with various parameters is also possible such as a warning flag at 90% capacity, temperature near safety shut-off, marked input fluctuations, constantly at the upper limit of distance. The internal data bus D-I of device 110 is a highly advantageous option and offers the opportunity for realizing more extensive control and supervision options. However, the internal data bus D-I is not an essential option to all embodiments according to the invention. According to FIG. 1, the primary portion 1 and the secondary portion 1′ of the device both optionally include respective integrated data transmission devices 30, 30′ for contactless energy transmission in the data transmission devices 40, 40′, which transmit digital data bidirectionally between the primary portion 1 and the secondary portion 1′. Thus, for example, an automation component or a field unit can not only be supplied with current via the device for contactless energy transmission, but also with data. The device for contactless energy transmission thus supplies combined contactless important interfaces, e.g., for interaction. The data transmission devices 30, 30′ are preferably identical in design, so that the data can be transmitted bidirectionally without a preferred direction.

The transmission is preferably performed optically with at least one sending element and at least one receiving element in both of the data transmission devices 30 and 30′. In the illustrated embodiment, the data transmission devices 30 and 30′ are both arranged centrally (in the x and y directions) and with a light incidence and emergence surface in the plane of the cover plate 3, 3° insofar as possible.

Bidirectional transmission can take place in full duplex mode, for example, using light of different wavelengths for the two directions of transmission. A full duplex mode process can be performed even at the same wavelength for the two directions of transmission, e.g., using differently modulated signals in the two directions of transmission.

Alternatively, bidirectional transmission is also possible in a half-duplex process, for example by using a time-multiplexed method with alternating successive time slots for the two directions of transmission.

1-14. (canceled)

15. A device for contactless inductive energy transmission comprising
(a) from a primary portion and to a secondary portion, each including at least one coil inductively coupled together via an air gap, and
(b) at least one condition monitoring device for monitoring at least one condition parameter of at least one of the primary portion and the secondary portion, said at least one condition monitoring device including a parameterization unit with which at least one limit value for at least one condition parameter or at least one value correlated with the at least one condition parameter can be set and/or modified.

16. The device according to claim 15, wherein said condition monitoring device of the primary portion is coupled with a data transmission device of said primary portion and said condition monitoring device of the secondary portion is coupled with a data transmission device of said secondary portion.

17. The device according to claim 15, wherein said condition monitoring device of the primary portion is coupled with at least one sensor for monitoring at least one condition parameter of the primary portion, and said condition monitoring device of the secondary portion is coupled with at least one sensor for monitoring at least one condition parameter of the secondary portion.

18. The device according to claim 17, wherein said condition monitoring device of the primary portion monitors a condition parameter of said primary coil.

19. The device according to claim 17, wherein said condition monitoring device of the secondary portion monitors a condition parameter of said secondary coil.

20. The device according to claim 16, wherein said data transmission device of said primary portion transmits data over at least one data bus to a control unit or directly to a terminal unit.

21. The device according to claim 16, wherein said data transmission device of said secondary portion transmits data over at least one data bus to the data transmission device of the secondary portion.

22. The device according to claim 21, wherein said data transmission device of said secondary portion transmits data over at least one data bus to at least one field unit.

23. The device according claim 20, wherein said at least one data bus is coupled directly to said control unit with at least one terminal unit for data input and/or data output.

24. The device according to claim 15, and further comprising an identification address for identifying and addressing the device in a control system.

25. The device according to claim 23, wherein said at least one terminal unit comprises a screen surface designed for visual display of the at least one condition parameter or information correlated with the at least one condition parameter and/or for setting condition parameters.

26. The device according to claim 16, wherein a respective data transmission device of said at least one primary portion and said secondary portion transmits the condition parameters obtained over a separate data bus exclusively for transmitting these values.

27. The device according to claim 16, wherein said data transmission devices transmit data over the air gap and wherein data interfaces for at least one of said primary portion and said secondary portion comprise a data transmission unit for transmitting data via the air gap.

28. A control system with at least one terminal unit, a control unit, at least one field unit and at least one device according to claim 15.

29. An operating method for a device for contactless inductive energy transmission from a coil of a primary portion to a coil of a secondary portion via an air gap which forms part of a control system, comprising the steps of:
(a) monitoring at least one condition parameter with a condition monitoring device of at least one of the primary portion and the secondary portion, the condition monitoring device comprising sensors and a parameterization unit;
(b) transmitting the monitored condition parameters in data form with a data transmission device to at least one of a control unit and a terminal unit; and
(c) setting and/or modifying at least one limit value of the parameterization unit, the at least one limit value being configured for individual or multiple condition parameters or at least one value correlated with the individual or multiple condition parameters.

30. The operating method according to claim 29, wherein functional operations comprising the steps of shutting down the transmission or reducing power are performed independently or under control, with and without parameterized notification.

31. The operating method according to claim 29, and further comprising the step of displaying at least one condition parameter and information associated with the at least one condition parameter on a display of the terminal unit.
